(19) United States
(12) Patent Application Publication
(10) Pub. No.: US 2026/0087339 A1
(43) Pub. Date: Mar. 26, 2026

(54) APPARATUS WITH PARALLEL ARTIFICIAL INTELLIGENCE COMPUTATION CIRCUIT AND METHODS FOR OPERATING THE SAME

(71) Applicant: Micron Technology, Inc., Boise, ID (US)

(72) Inventors: Rohit Sehgal, San Jose, CA (US); Nitin N. Okhade, Fremont, CA (US); Rohit Sindhu, San Jose, CA (US)

(21) Appl. No.: 19/323,995

(22) Filed: Sep. 9, 2025

Related U.S. Application Data
(60) Provisional application No. 63/698,795, filed on Sep. 25, 2024.

(51) Int. Cl. G06N 3/065; G06F 8/71; G06F 12/02; G06F 13/16; G06F 13/42; G06F 18/15; G06F 18/214

(52) U.S. Cl. CPC G06N 3/065; G06F 8/71; G06F 12/0246; G06F 13/1673; G06F 13/42; G06F 18/15; G06F 18/2148; G06F 2213/0024; G06F 2213/0026

(57) ABSTRACT

Methods, apparatuses, and systems related to a memory drive configured for Artificial Intelligence (AI) training are described. The memory drive may include Neural Processing Units (NPUs) that preprocess raw data for training an AI model.

### CROSS-REFERENCE TO RELATED APPLICATIONS

The present application claims priority to U.S. Provisional Patent Application No. 63/698,795, filed Sep. 25, 2024, the disclosure of which is incorporated herein by reference in its entirety.

This application contains subject matter related to a U.S. Provisional Patent Application by Rohit Sehgal et al. titled “APPARATUS WITH EXPANDED ARTIFICIAL INTELLIGENCE TRAINING CIRCUIT AND METHODS FOR OPERATING THE SAME.” The related application is assigned to Micron Technology, Inc., and is identified as U.S. Application No. 63/698,780, filed Sep. 25, 2024. The subject matter thereof is incorporated herein by reference thereto.

### TECHNICAL FIELD

The disclosed embodiments relate to devices, and, in particular, to electronic devices with parallel Artificial Intelligence (AI) computation circuits and methods for operating the same.

### BACKGROUND

An apparatus (e.g., a processor, a memory system, and/or other electronic apparatus) can include one or more semiconductor circuits configured to store and/or process information. For example, the apparatus can include a memory device, such as a volatile memory device, a non-volatile memory device, or a combination device. Memory devices, such as dynamic random-access memory (DRAM), can utilize electrical energy to store and access data.

With technological advancements in embedded systems and increasing applications, the market is continuously looking for faster, more efficient, and smaller devices. To meet the market demands, the semiconductor devices are being pushed to the limit with various improvements. Improving devices, generally, may include increasing circuit density, increasing operating speeds or otherwise reducing operational latency, increasing reliability, increasing data retention, increasing functionalities, reducing power consumption, or reducing manufacturing costs, among other metrics.

### BRIEF DESCRIPTION OF THE DRAWINGS

FIG. 1 is a schematic block diagram of a computing system in accordance with an embodiment of the present technology.

FIG. 2 is a schematic block diagram of a memory device in accordance with an embodiment of the present technology.

FIG. 3A-FIG. 3E are block diagrams illustrating parallel data processing of the memory device in accordance with an embodiment of the present technology.

FIG. 4 is a cross-sectional view of an example system-in-package (SiP) device in accordance with an embodiment of the present technology.

FIG. 5A is a flow diagram illustrating a first example method of operating an apparatus in accordance with an embodiment of the present technology.

FIG. 5B is a flow diagram illustrating a second example method of operating an apparatus in accordance with an embodiment of the present technology.

FIG. 6 is a schematic view of a system that includes an apparatus in accordance with an embodiment of the present technology.

### DETAILED DESCRIPTION

As described in greater detail below, the technology disclosed herein relates to an apparatus including a parallel AI computation circuit. The apparatus can include a computing system, such as an enterprise computing system, a server, a distributed computing system, a personal computer, and/or the like configured to train AI models. The parallel AI training circuit can include components and arrangements thereof configured to provide increased parallel processing capabilities during AI model training.

As an illustrative example, the computing system can include a memory device (e.g., a Compute Express Link (CXL) based memory module/drive) external to both accelerators (e.g., Graphics Processing Units (GPUs)) and main processors (e.g., Central Processing Units (CPUs)). The memory device can include storage devices, such as Dynamic Random-Access Memory (DRAM) chips, arranged to provide multiple channels that each include multiple ranks of memory cells/locations. Further the memory device can include one or more Neural Processing Units (NPUs) for each memory channel. The memory device can include circuit/logic configured to selectively couple the NPU to one of the ranks within the corresponding channel while allowing other channel(s) to communicate data. Accordingly, for each channel, the parallel AI computation circuit can allow one or more ranks to communicate data (e.g., receive new/raw data or send processed data) while allowing the NPU(s) to operate on data stored within one or more other ranks within the same channel. In some embodiments, the memory device with the parallel AI computation circuit can be used to pre-process training data, and the pre-processed result from the memory device can be provided to the processor/accelerator for model training.

In addition to the NPUs and the parallel rank-control configuration, the memory device can include persistent memory and/or interfaces to persistent memory. The memory device can be configured to locally store the computing results of the NPUs. Continuing with the training data preprocessing example, the memory device can store the preprocessing results in the persistent memory with an identifier (e.g., a time stamp, a session identifier, and/or the like) for check-pointing. Accordingly, the memory device can provide the preprocessing results at a later time using the identifier, such as for accessing previous versions of the model or previous iterations of the training process.

For AI training applications, the memory device with the parallel AI computation circuit can reduce computational requirements of the accelerator (e.g., GPUs), thereby reducing the overall training time required to generate new models. The parallel computing configuration can leverage the NPUs to process the data while (1) new data is received at the memory device and/or (2) processing results are communicated back from the memory device. Accordingly, the overall computing system can divert more resources of the accelerators to the training and use the memory device for training data preprocessing and/or other similar peripheral computations.

Moreover, in some embodiments, the memory device can include an external memory module (e.g., a CXL memory module) that has significantly higher memory capacity than memory local to the GPU (e.g., the High Bandwidth Memory (HBM) within the GPU package). Thus, in preprocessing the training data, the memory device can leverage the increased memory capacity to operate on larger segments of data than the GPUs. Moreover, the memory device can leverage the multiple parallel channels and the corresponding NPUs to perform the computations faster than preprocessing the training data using the GPUs.

### Example Environment

AI and Machine Learning (ML) often require computing systems to learn from data and generalize the learning to unseen/subsequent data. In doing so, the result of the learning process, such as the resulting AI or ML model, can be used to perform tasks without explicit instructions. The learning process can include training where the computing system learns or identifies properties or features from training data. In other words, in order to learn, the computing system can extrapolate patterns, features, or the like from the training data. For simplicity, AI and ML will be used interchangeably therein.

The training process can include data preprocessing. The preprocessing process can involve transforming raw training data into a format configured for the learning mechanism (e.g., the ML algorithms, such as the Neural Network, Singular Value Decomposition (SVD), Random Forrest, etc.). Additionally, the preprocessing process can involve transforming the raw data into a format or a result derived from the raw data associated with the targeted features or subjects of the learning, the available features of the training data, or a combination thereof.

For conventional computing systems, the preprocessing is performed at the GPUs. The CPU typically obtains the raw training data from a network drive and passes the obtained raw data to the GPUs. The GPUs can then preprocess the raw training data to generate the preprocessed training data. The GPUs can further operate on the preprocessed training data to train the model.

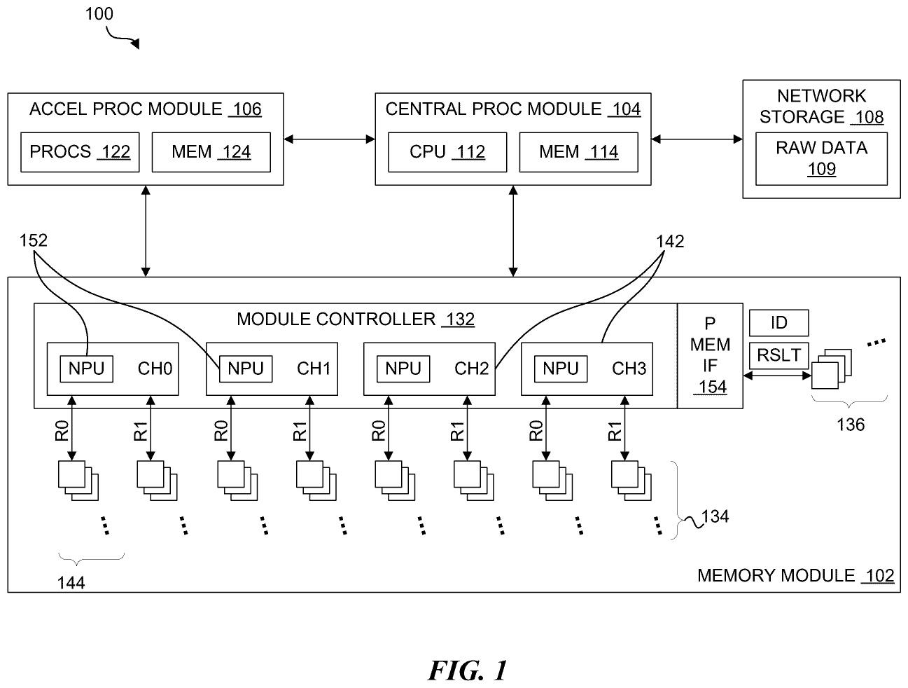

In contrast, embodiments of the present technology can include a parallel AI computation circuit. To illustrate the parallel AI computation circuit, FIG. 1 is a schematic block diagram of a computing system 100 in accordance with an embodiment of the present technology. The computing system 100 can include a computational system, such as an enterprise computing device, a server, a distributed computing system, a personal device, and/or the like, configured to implement AI training and/or AI implementation. The computing system 100 can include a memory module 102 communicatively coupled to a central processing module 104 and an accelerator processing module 106. Additionally, the central processing module 104 can be communicatively coupled to a network storage device 108 (e.g., Network Attached Storage (NAS)).

The central processing module 104 can include a computing unit functioning as a master control for the computing system 100. The central processing module 104 can include one or more CPUs 112 and central embedded memories 114. In some embodiments, the central processing module 104 can communicate with the network storage device 108 to access or obtain raw training data 109.

The accelerator processing module 106 can include an additional computing unit configured to perform peripheral or targeted computations. For example, the accelerator processing module 106 can include a GPU configured to perform targeted computations, such as aspects of ML training, graphics data processing, and/or the like, peripheral to and/or assigned by the central processing module 104. The accelerator processing module 106 can include one or more local processing cores or logic 122 along with accelerator embedded memory 124 (e.g., HBM).

The memory module 102 can include a memory device configured to store data. The memory module 102 can be a device external to (e.g., separately housed or packaged from) to the central processing module 104 and the accelerator processing module 106. For example, the memory module 102 can include a separate package or an external drive that includes memory cells (e.g., DRAM chips and/or NAND Flash chips) outside of the processing modules.

The memory module 102 can be directly coupled to the central processing module 104 and/or the accelerator processing module 106. For example, the memory module 102 can use communicative links, connections, protocols, and/or the like corresponding to CXL, Ultra Accelerator Link (UAL), Ethernet, Peripheral Component Interconnect Express, and/or the like. In some embodiments, the memory module 102 can communicate with the accelerator processing module 106 through the central processing module 104. In other embodiments, the memory module 102 can communicate directly with accelerator processing module 106 without communicating through the central processing module 104.

The memory module 102 can include a module controller or a local memory controller 132 (e.g., a logic circuit) along with a first or a fast memory 134 and/or a second or a persistent memory 136. The first memory 134 can include memory circuits configured to provide faster and/or less organized (e.g., random) access to data in comparison to the second memory 136. The first memory 134 may be configured to retain the data while the power is continuously available, while the second memory 136 can be configured to retain the stored data when the power is removed from the memory. For example, the first memory 134 can include DRAM, and the second memory 136 can include NAND Flash. In some embodiments, the memory module 102 can include the first memory 134 and the second memory 136 within the same physical grouping, such as within the same encasing, the same packaging, the same Printed Circuit Board, and/or the like. In other embodiments, the second memory 136 can be separately grouped from the memory module 102 while maintaining the communicative coupling.

The memory module 102 can include circuitry and/or circuit configurations that provide increased parallel processing capabilities. For example, the memory module 102 can correspond to and/or include the parallel AI computation circuit configured to provide the parallel and concurrent processing capabilities that target AI training processes (e.g., training data preprocessing computations). For providing the parallel and concurrent processing, the memory module 102 can have the first memory 134 configured into multiple memory channels 142 that each have two or more memory ranks 144. For the example illustrated in FIG. 1, the memory module 102 can have four channels (CH0-CH3) with each channel having two ranks (R0 and R1).

Further, the memory module 102 can have NPUs 152 configured to process the data in the first memory 134 for increasing the parallel processing capabilities. For example, the module controller 132 can include one or more NPUs 152 coupled and targeted to corresponding memory channel 142. For the example illustrated in FIG. 1, the memory module 102 can include one NPU dedicated for each memory channel, thereby having access to two memory ranks therein. In other examples, each channel can include three or more ranks, and the module controller 132 can include two or more NPUs 152.

As an illustrated example of the parallel processing, the memory module 102 can receive the raw training data 109 from the central processing module 104 (e.g., over a CXL interface) for preprocessing. As the data is received, the memory module 102 (via, e.g., the module controller 132) can store the received data into one of the ranks (e.g., R0) across the channels. Once the first received set of the raw training data 109 is stored in one of the ranks, the module controller 132 can lock the corresponding ranks from communicating (e.g., further receiving or sending) further data/information. Concurrently (e.g., substantially simultaneously), the module controller 132 can open and avail one other rank (e.g., R1) within each channel to receive the next set of the raw training data 109. While the memory module 102 stores the next set of the raw training data 109 into the opened rank, the module controller 132 can concurrently assign and utilize the NPUs 152 to operate on the data stored in the closed ranks (e.g., R0). For preprocessing, the NPUs 152 can perform the corresponding data formatting operations using the set of the raw training data 109 stored in the closed memory rank 144 (e.g., R0).

In preprocessing, the NPUs 152 can operate on the raw data by evaluating, filtering, manipulating, selecting/discarding, highlighting, sorting, encoding, and/or the like on the raw data to improve the data quality for the subsequent training/learning process. Effectively, the NPUs 152 can execute the instructions (e.g., the commands provided by the central processing module 104 and/or the instructions preloaded in the locally embedded memory) to implement feature selection or transformation, data normalization, data augmentation, noise filtering, customized algorithm, and/or the like on the raw training data 109. For the memory module 102, the NPUs 152 can operate within the closed rank, thereby transforming the raw training data 109 or a portion thereof in the closed rank into a preprocessed result/training data. The NPUs 152 can store the preprocessed result within the closed rank, such as by replacing the raw training data 109 and/or by storing the preprocessing results at a predetermined location within each of the rank.

Once the NPUs 152 complete the computations, the module controller 132 can change the open/closes statuses of the ranks 144 such that (1) the previously closed/processed rank (e.g., R0) becomes open and (2) the previously opened/communicating rank (e.g., R1) becomes closed to further communications. Along with the changed communication statuses, the module controller 132 can reassign the NPUs 152 to the newly closed ranks (e.g., R1). Based on the updates, the memory module 102 can offload the processing results from the reopened rank (R0) and then receive the next set of the raw training data 109. Concurrently, the module controller 132 can use the NPUs 152 to operate on the data stored in the newly closed rank (R1). Accordingly, the memory module 102 can continuously receive segments or instances of the raw training data 109 while/concurrently as operating on the previously received segments/instances of the raw training data 109 and while/concurrently as sending the results of such computational results to the central processing module 104 and/or directly to the accelerator processing module 106.

In some embodiments, the memory module 102 can further store the processing results at the second memory 136 via a persistent memory interface 154. For example, the module controller 132 can access the processing results for communication after the previously closed/processed rank opens. Before communicating the processed result out from the memory module 102, the module controller 132 can provide the processed result to the second memory 136 through the persistent memory interface 154. The module controller 132 and/or the second memory 136 can store the processing results with a unique identifier (e.g., uniquely identifiable based on time, data segment, processing session, and/or the like). Accordingly, the memory module 102 can provide a backup of the processing result for checkpointing or model reversing features. In other words, when the central processing module 104 and/or the accelerator processing module 106 needs to access a previous version of the preprocessing results and/or a prior version of the model, the memory module 102 can identify the corresponding preprocessing result using the unique identifier. The memory module 102 can access the requested preprocessing results from the second memory 136 without re-receiving and recomputing the corresponding raw training data 109.

### Parallel Processing Architecture

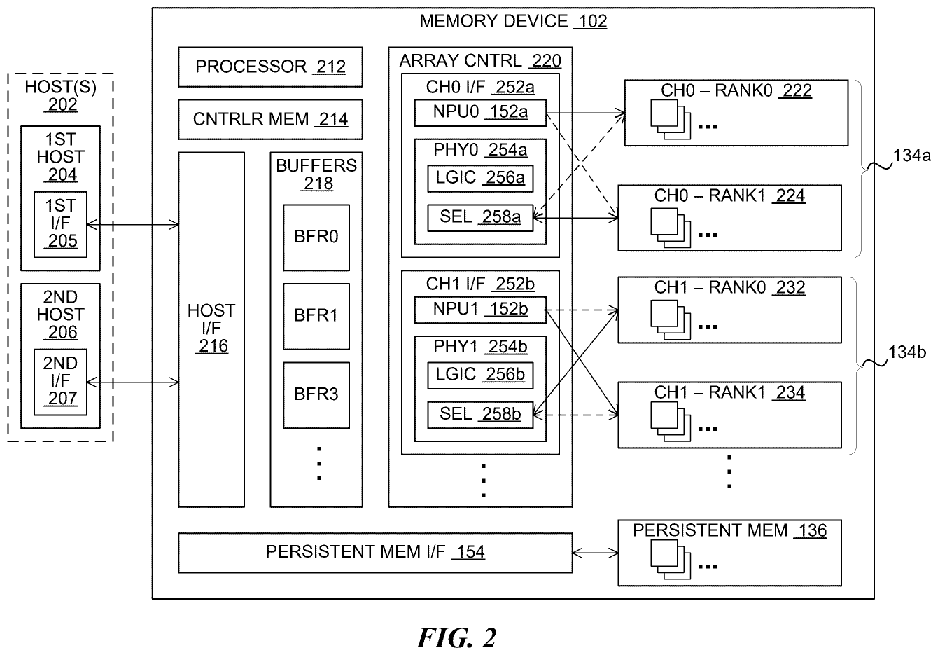

Illustrating an example architecture for the parallel processing, FIG. 2 is a schematic block diagram of a memory device (e.g., the memory module 102) in accordance with an embodiment of the present technology. The memory module 102 can include circuitry and/or circuit configurations that provide increased parallel processing capabilities. For example, the memory device can include (e.g., at the module controller 132 of FIG. 1) an internal processor or a local logic circuit 212 along with embedded memory 214. The local processor 212 and the embedded memory 214 can be used to control the operation of the memory module 102, including the increased parallel processing capabilities.

The memory module 102 can include a host interface 216 to facilitate communication with one or more host devices 202. For example, a first host device 204 can include the central processing module 104 of FIG. 1, and a second host device 206 can include the accelerator processing module 106 of FIG. 1. Each of the hosts can have an interface circuit (e.g., a first interface 205 and a second interface 207) that correspond to a predetermined communication protocol or standard (e.g., CXL, UAL, PCI, Ethernet, and/or the like). Accordingly, the host interface 216 can have a configuration that also corresponds to the predetermined communication protocol or standard of the hosts 202.

In some embodiments, the memory module 102 can include a set of buffers 218 to further facilitate the data communication in and out of the memory device. For example, the memory module 102 can use the buffers 218 to deconstruct received data groupings (e.g., packets) and/or construct the data groupings for transmission. The buffers 218 can be sized according to external communication speed, internal processing speed (e.g., operating speed of the NPUs 152), internal communication speed to/from the channels 142 of FIG. 1, the number of the channels 142 and/or the ranks 144 of FIG. 1, the data grouping size, or a combination thereof.

The memory module 102 can include an array controller 220 (e.g., at the module controller 132) configured to control the operations of the first memory 134. The array controller 220 can facilitate the communications to and from the first memory 134 (e.g., between the buffers 218 and the first memory 134). In some embodiments, the array controller 220 can be configured to provide a separate set of circuits 252 for interfacing with each of the channels 142. Each of the dedicated channel interface circuits 252 can include a corresponding one or more NPUs 152 and the Physical Layer (PHY) communication circuits 254 (e.g., transmitters, receivers, connectors, and/or the like) used to send and receive the electrical representative of the communicative data. The PHY circuits 254 may each include related logic circuit 256 (e.g., a Register Transfer Level (RTL) logic) that operates according to a selection status 258, and/or the like.

The logic circuit 256 can be configured to control a flow of data in and out of the corresponding channel. Accordingly, the logic circuit 256 can set or update the selection status 258 (e.g., open/closed statuses of the ranks within the channel) and allow the flow of data accordingly. Based on the selection status 258, the logic circuit 256 can connect the corresponding NPU to the prepared rank within the channel, such as the closed rank having raw data stored therein and ready for computation.

For the example illustrated in FIG. 2, CH0 interface circuit 252a can be configured to facilitate operations of memory channel CH0 134a. The CH0 134a can include a rank R0 (CH0-R0) 222 and a rank R1 (CH0-R1) 224. To control and operate on the data stored therein, the CH0-R0 222 and the CH0-R1 224, the CH0 interface circuit 252a can include an NPU0 152a and a PHY0 254a. The PHY0 254a can further include a RTL0 256a and a selector0 258a. Similarly, CH1 interface circuit 252b can be configured to facilitate operations of memory channel CH1 134b. The CH1 134b can include a rank R0 (CH1-R0) 232 and a rank R1 (CH1-R1) 234. To control the CH1-R0 and the CH1-R1, the CH1 interface circuit 252b can include an NPU0 152b and a PHY1 254b. The PHY1 254a can further include a RTL1 256a and a selector1 258a.

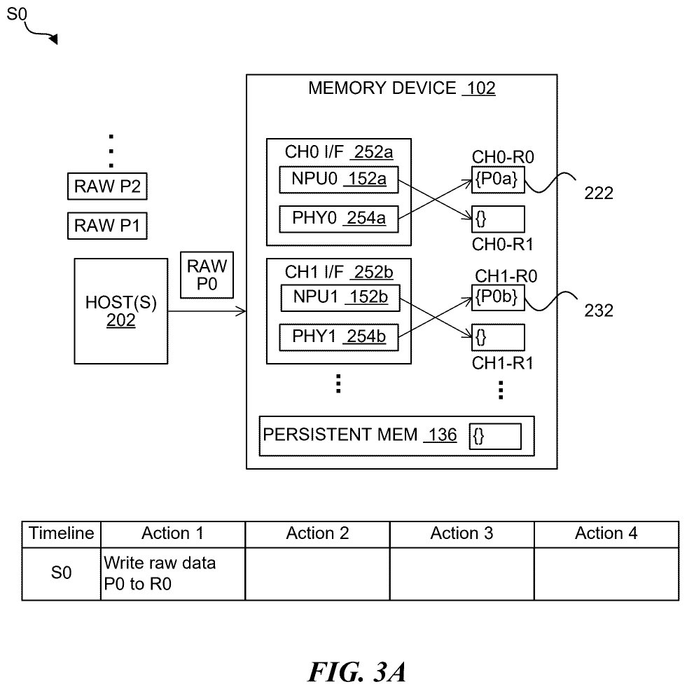

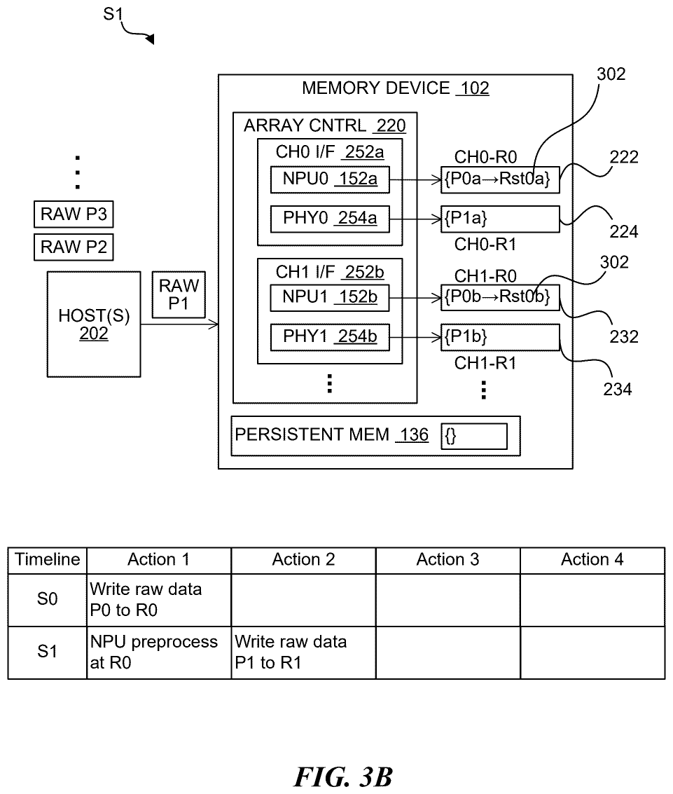

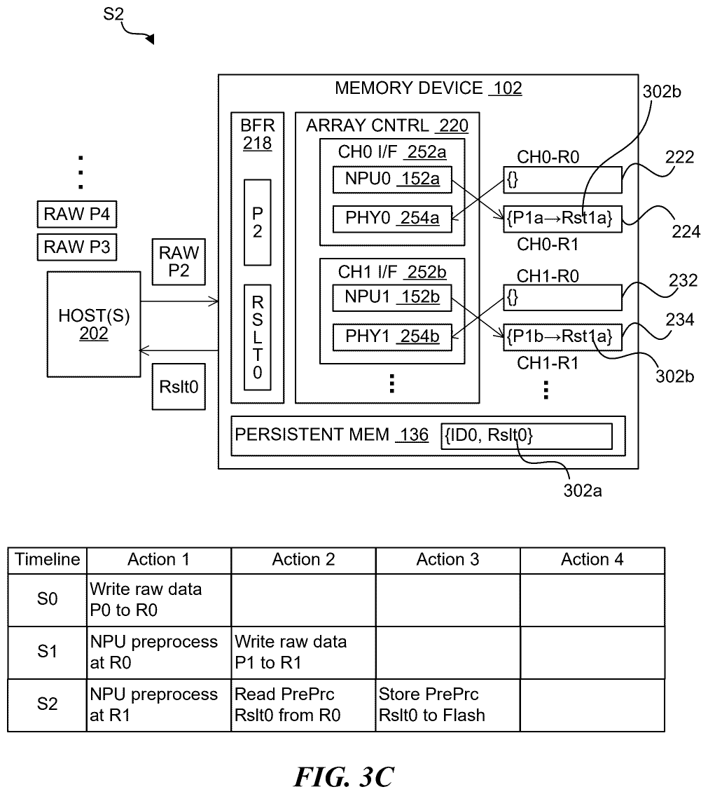

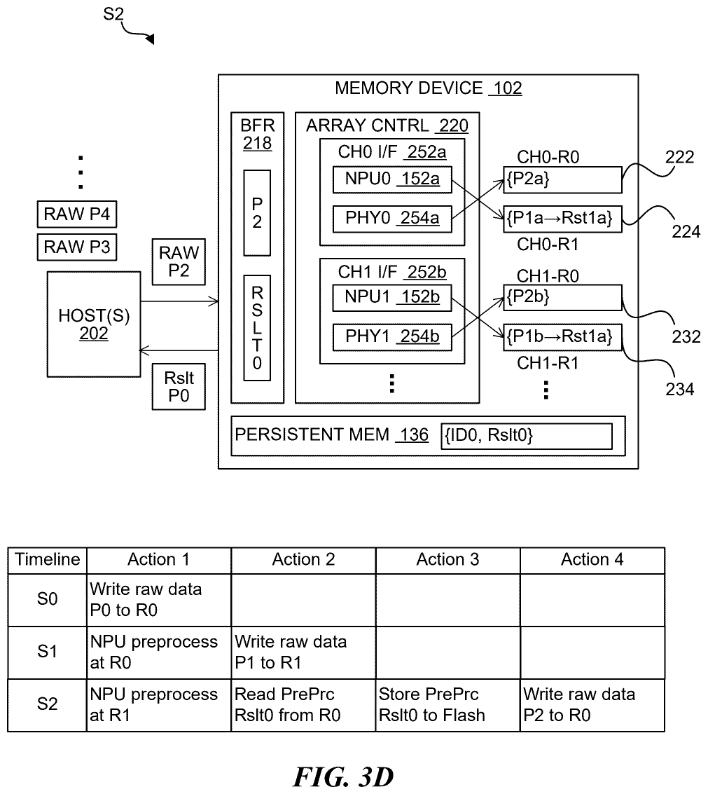

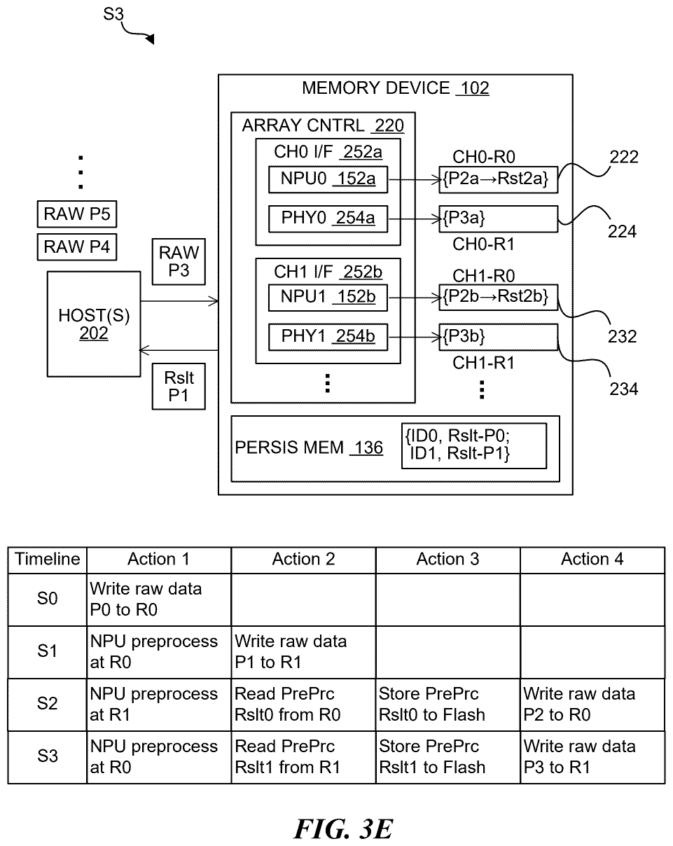

Further showing the operations, FIG. 3A-FIG. 3E are block diagrams illustrating parallel data processing of the memory module 102 in accordance with an embodiment of the present technology. FIG. 3A illustrates an initial processing phase/iteration S0. During iteration S0, the memory module 102 can use the interface circuits 252 to open the memory R0 ranks (e.g., the rank R0 222 and 232 and more) across one or more or all channels to receive incoming raw data (e.g., packet P0 of the raw training data 109 of FIG. 1). For example, the memory module 102 can perform/complete the CPU commanded write and/or divide the packet P0 into predetermined subsections that are each stored into one of the ranks in the corresponding channels.

FIG. 3B illustrates a next processing iteration S1. After receiving the data, the interface circuits can use the PHY circuits to change the selection status 258, thereby closing the R0 ranks from further communication and opening the R1 ranks for subsequent communications (e.g., the next packet (P1) of the raw training data 109). During the iteration S1, the channel interface circuits 252 can use the NPUs 152 to operate on (e.g., the computations corresponding to the preprocessing and data formatting algorithm) the raw data P0 stored in the now closed R0 ranks. Accordingly, the NPUs 152 can generate preprocessing result or preprocessed training data 302 (Result0) from operating on the raw data P0 in the R0 ranks. Concurrently, the channel PHYs 254 can load the next set/packet P1 of the raw training data 109 into the open R1 ranks.

When the next raw data P1 is stored in the open R1 ranks and/or the preprocessing of the raw data P0 in the closed R0 ranks is complete, the interface circuits can adjust the status 258 such that the closed R0 ranks now revert back to open and the open R1 ranks now revert to closed status. Correspondingly, FIG. 3C and FIG. 3D illustrates a next processing iteration S2.

During iteration S2, the memory module 102 can leverage the NPUs 152 to operate on the raw data P1 stored in the closed R1 ranks. Similarly as described above, the NPUs 152 can perform the preprocessing computations to generate Result1 corresponding to the raw data P1.

Concurrently, the memory module 102 can read the preprocessing results (Result0, derived from the raw data P0) from R0 ranks as illustrated in FIG. 3B. The read Result0 can be sent to one or more of the hosts 202 (e.g., directly to the CPU and/or directly to the GPU). In addition to sending Result0 to the host 202, the memory module 102 can store the preprocessing result in the persistent memory 136 along with a unique identifier (IDO).

After reading the Result0, the PHYs can load the next packet (P2) of the raw training data 109 into the now open R0 ranks as illustrated in FIG. 3C. In reading the Result0 and/or receiving the raw data packet P2, the memory module 102 can utilize the buffer 218 to match speed and maximize bandwidth. For example, the memory module 102 can load the incoming raw data packet P2 into the buffer 218 while reading from the R0 ranks and/or load the read Result0 into the buffer 218 before sending to the hosts 202 and/or storing in the persistent memory 136.

FIG. 3E illustrates a following processing iteration S3. During iteration S3, the memory module 102 can perform the parallel operations using the other channels in comparison to iteration S2. For example, the memory module 102 can change the open/closed statuses and then use the NPUs 152 to operate on the raw data P2 in the closed R0 ranks, read Result from the R1 ranks, store Result1 into the persistent memory 136, send Result1 to the host(s) 202, further receive and load the next packet P3 of the raw training data 109 into the R/ranks in parallel. For example, the memory module 102 can perform the data communications (e.g., sending Result1 and/or receiving the raw data P3) while simultaneously preprocessing the raw data P2, backing up the Result1, and/or the like.

The preprocessing results (e.g., result0, result1, etc.) can be communicated to one or more of the hosts 202 using the host interface 216. In some embodiments, the preprocessing results can be communicated directly to the accelerator processing module 106 and/or the central processing module 104. The preprocessing results can be communicated, directly or indirectly through the central processing module 104, to the accelerator processing module 106 for training the AI/ML model. As described above, the host interface 216 can facilitate receiving of raw data in parallel with and/or between sending packets of the outgoing preprocessing results.

### Accelerator Architecture

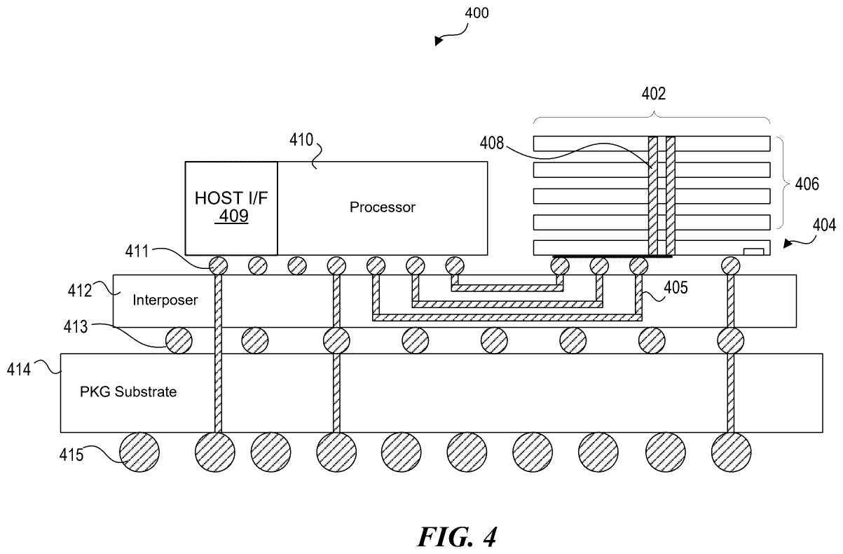

FIG. 4 is a cross-sectional view of an example system-in-package (SiP) device 400 in accordance with an embodiment of the present technology. The SiP 400 can include a memory device 402 and a processor 410 (e.g., a CPU, a GPU, or the like), which are packaged together on a package substrate 414 along with an interposer 412. The processor 410 may act as a host device of the SiP 400. In turn, the SiP 400 can act as a host device, such as the second host 206 of FIG. 2 and/or the accelerator processing module 106 of FIG. 1.

In some embodiments, the memory device 402 may be a HBM device that includes an interface die (or logic die) 404 and one or more memory core dies 406 stacked on the interface die 404. The memory core dies 406 can include DRAM devices/dies, NAND devices/dies, and/or other types of memory devices (e.g., SRAM) as main memory configured to store data provided by the processor 410 and to provide access of the stored data to the processor 410. The memory device 402 can further include additional and/or supplementary memory circuits (e.g., SRAM, DRAM, NAND, etc.), located within and/or outside of the core dies 406, configured for internal uses (e.g., remaining inaccessible to the processor 410). The memory device 402 can include one or more TSVs 408, which may be used to couple the interface die 404 and the core dies 406.

The interposer 412 (e.g., a silicon interposer) can provide electrical connections between the processor 410, the memory device 402, and/or the package substrate 414. For example, the processor 410 and the memory device 402 may both be coupled to the interposer 412 by a number of internal connectors (e.g., micro-bumps 411). The interposer 412 may include channels 405 (e.g., an interfacing or a connecting circuit) that electrically couple the processor 410 and the memory device 402 through the corresponding micro-bumps 411. While three channels 405 are shown in FIG. 4, greater or fewer numbers of channels 405 may be used. The interposer 412 may be coupled to the package substrate by one or more additional connections (e.g., intermediate bumps 413, such as C4 bumps).

The package substrate 414 can provide an external interface for the SiP 400. The package substrate 414 can include external bumps 415, some of which may be coupled to the processor 410, the memory device 402, or both. The package substrate may further include direct access (DA) bumps coupled through the package substrate 414 and interposer 412 to the interface die 404.

In some embodiments, the SiP 400 can have a host interface 409 included within or separately coupled to the processor 410. The host interface 409 can facilitate a targeted communication, such as with the central processing module 104 of FIG. 1 and/or the memory module 102 of FIG. 1. For example, the host interface 409 can facilitate the CXL protocol, the UAL protocol, and/or the like. The host interface 409 can enable the processor 410 to communicate with and utilize the memory module 102 in addition to and/or instead of the memory device 402.

### Control Flow

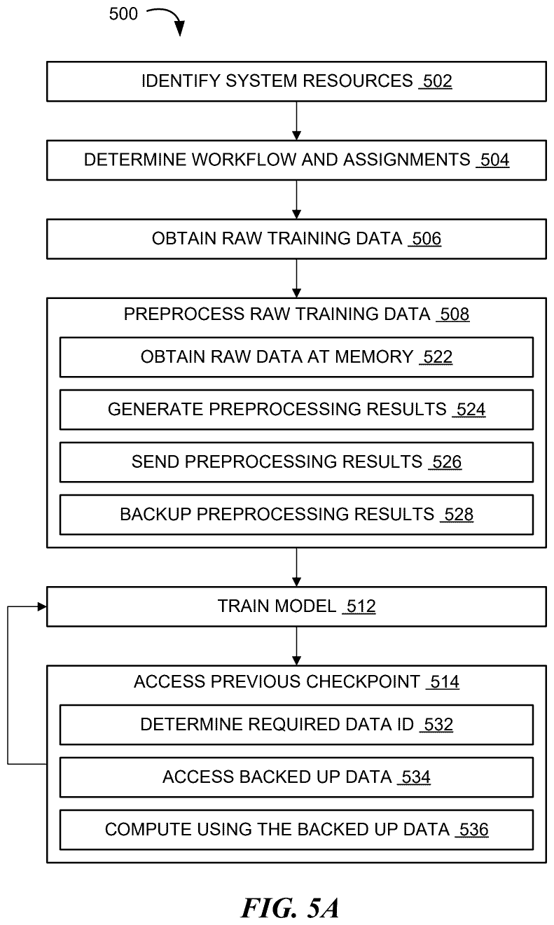

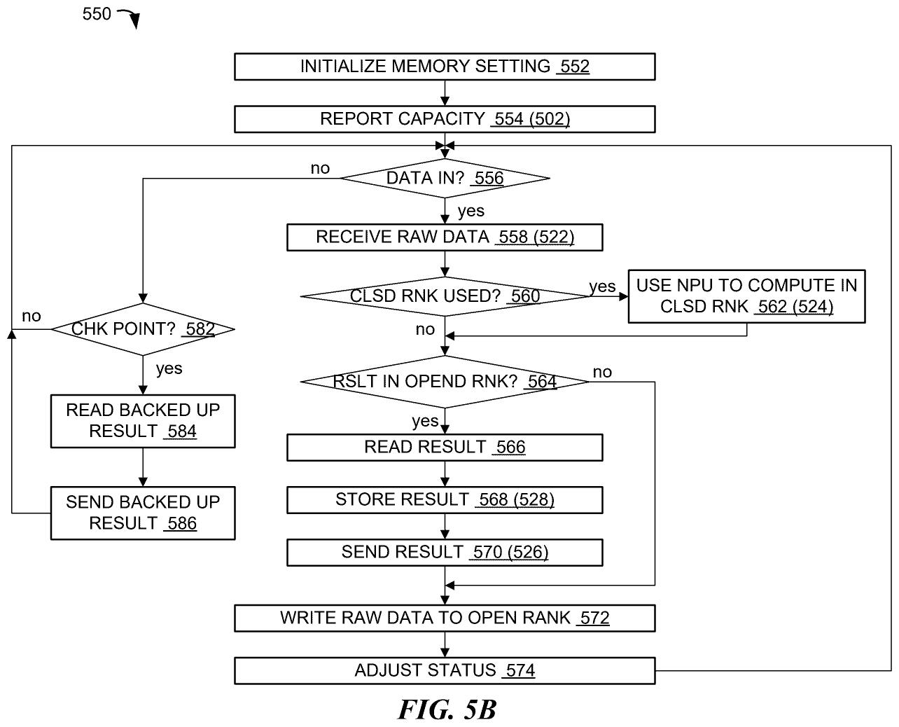

FIG. 5A is a flow diagram illustrating a first example method 500 of operating an apparatus (e.g., the computing system 100 of FIG. 1, the memory module 102 of FIG. 1, or a combination thereof) in accordance with an embodiment of the present technology. For example, the method 500 can include operating the computing system 100 having the memory module 102 therein, and leveraging the memory module 102 for computations in training an AI model. In some embodiments, the memory module 102 can include the NPUs configured to preprocess the raw training data. The memory module 102 may be configured to preprocess the raw training data while (e.g., concurrently with, simultaneous to, parallel to) (1) sending a previous result to one or more of the hosts 202 of FIG. 2 and/or (2) receiving a next raw data from one or more of the hosts 202.

The method 500 can include identifying system resources as illustrated at block 502. For example, the central processing module 104 of FIG. 1 can identify the system resources based on communicating with coupled devices within the computing system 100, such as during bootup, and/or based on a predetermined system data. Accordingly, the central processing module 104 can identify data processing capacity (e.g., number of processors/cores/logic), communication capability, data storage capacity, or a combination thereof of the coupled devices. In some embodiments, the memory module 102 can report its processing capabilities (e.g., the existence and/or the capacities of the NPUs 152 of FIG. 1 within the memory module 102) to the central processing module 104.

As shown at block 504, the method 500 can include determining workflow and task assignments. For example, the central processing module 104 can identify the computations or tasks to be performed by the devices, such as the memory module 102 and the accelerator processing module 106 of FIG. 1, within the computing system 100. For AI training applications, the central processing module 104 can assign the training data preprocessing task to the memory module 102 and using the preprocessed to train the AI model to the accelerator processing module 106.

At block 506, the computing system 100 can access/obtain raw training data (e.g., the raw training data 109 of FIG. 1). The central processing module 104 can obtain/access the raw training data 109 from the network storage device 108 of FIG. 1. The central processing module 104 can provide the raw training data 109 according to the workflow/assignment. For example, the memory module 102 can receive the raw training data 109 from the central processing module 104 along with a command to preprocess the received data.

At block 508, the computing system 100 can preprocess the raw training data, such as by reformatting the raw training data for AI model training. In some embodiments, the computing system 100 can use the memory module 102 and the NPUs 152 therein to preprocess the raw training data 109, thereby generating the preprocessing results (e.g., the preprocessed training data 302 of FIG. 3B). For example, the computing system 100 can use the memory module 102 to format the raw training data 109, label or categorize portions within the raw training data 109, identify tokens within the raw training data 109, and/or the like. The memory module 102 can operate on the raw training data 109 and perform the corresponding computations for the preprocessing according to predetermined instructions and processes.

In some embodiments, the computing system 100 can leverage the memory module 102 to preprocess the raw training data 109 using a parallel processing mechanism. For example, the memory module 102 can obtain the raw training data 109 as shown at block 522, and generate the preprocessing results at block 524, while or in parallel with sending the preprocessing results as shown in block 526, backing up the preprocessing results at block 528, and repeating the obtaining of next raw data of block 522. As described above, the memory module 102 can leverage the multiple ranks within each channel such that the NPUs 152 operate on a reference set of raw data in one rank while (1) sending out a preprocessing result generated from operating on a preceding set of raw data received before the reference set from another rank and/or (2) receiving a next set of raw data after having received the reference set into the other rank. To enable the parallel processing, the memory module 102 can provide open communicative access to the communicating rank, such as for writing the raw training data and/or reading the preprocessed training data from the opened/communicating rank. Concurrently, the memory module 102 can couple an NPU assigned to the channel to the rank having received the raw data. Subsequently, the NPU can operate on data stored in the connected rank while the communicating rank communicates the data in and/or out. The memory module 102 can perform the parallel processing as described above with respect to FIG. 3A-FIG. 3E.

In some embodiments, the memory module 102 can send the preprocessing results directly to the GPU (e.g., without communicating through the CPU). In other embodiments, the CPU can receive the preprocessing results from the memory module 102 and then send the preprocessing results to the GPU with a corresponding command. Accordingly, the GPU can receive the preprocessing results from the memory module 102 through the CPU. The GPU can receive the preprocessing results, directly or indirectly, for training the AI module with the preprocessing results/training data.

With the preprocessing results at the accelerator processing unit (e.g., the GPU), the computing system can train the AI model as illustrated at block 512. For example, the GPU can perform the computations as commanded by the central processing module 104. The GPU can feed the preprocessed training data to one or more predetermined models/algorithms (e.g., Neural Network, Random Forrest, Singular Value Decomposition (SVD), and/or the like). Accordingly, the GPU can tune the model to learn features and/or patterns in the preprocessed training data and apply the learned results to subsequent inputs.

In some embodiments, the computing system 100 can revert to prior models and/or reverse incremental changes caused by one or more model training sessions. In doing so, the computing system 100 can recall a prior version of the model and/or training data to discard subsequently made changes and/or modify the subsequent training. As illustrated at block 514, the computing system 100 can access a previous checkpoint in the AI model training process as identified by the engineer, the developer, the computing system 100, or a combination thereof. In response, the central processing module 104 can determine the required identifier at block 532. The central processing module 104 can determine the identifier that represents a time, a session, a version, and/or the like associated with the checkpoint for the model, the training data, or both. For example, the central processing module 104 can identify the backup/checkpoint identifier provided by the memory module 102 when the required preprocessing results were generated/backed up (e.g., at block 528 during a prior iteration).

At block 534, the computing system 100 can access the backed up preprocessing results, such as the backed-up results corresponding to block 528. For example, the central processing module 104 can send a request or a read to the memory module 102 for the preprocessed training data using the required identifier. In response, the memory module 102 can use the identifier to access the older preprocessing results stored in the persistent memory 136 of FIG. 1. The memory module 102 can access the preprocessing results without recomputing or reformatting the corresponding raw training data. The older preprocessing results can be provided to the accelerator processing module 106 as described above, and the accelerator processing module 106 can use the checkpoint data to continue training the AI model.

FIG. 5B is a flow diagram illustrating a second example method 550 of operating an apparatus (e.g., the computing system 100 of FIG. 1, the memory module 102 of FIG. 1, or a combination thereof) in accordance with an embodiment of the present technology. For example, the method 550 can be for operating the memory module 102 to preprocess the raw training data. The method 550 can include operating the memory module 102 to perform parallel processing, such as preprocessing the raw training data while (1) sending a previous result to one or more of the hosts 202 of FIG. 2 and/or (2) receiving a next raw data from one or more of the hosts 202. In other words, the method 550 can describe the detailed operations of the memory module 102 within the method 500 of FIG. 5A.

At block 552, the memory module 102 can initialize memory settings. For example, the memory module 102 can implement the initialization as a part of installation, booting up process, and/or the like. The initialization process can include identifying the functional capacities of the memory module 102, such as by identifying the number of the NPUs 152 of FIG. 1 therein and/or the processing capabilities of the NPUs 152. Further, initialization can include setting the selection status 258 of FIG. 2 to a default state, such as by opening the first rank of each channel for communication and assigning to the NPUs 152 to the second rank of each channel. Similarly, the memory module 102 can initialize the data stored in the memory cells to include a predetermined pattern representative of being empty or not having been used (e.g., a set of consecutive ‘0’ values or a set of consecutive ‘1’ values).

At block 554, the memory module 102 can report its capabilities to the central processing module 104 of FIG. 1. For example, the memory module 102 can provide its device identifier, memory capacity, processing capacity (e.g., the number/processing speed of the NPUs 152), and/or the like. The memory module 102 can report its capabilities in association with the processes described for block 502 of FIG. 5A.

At decision block 556, the memory module 102 can determine whether it has received incoming raw data (e.g., the raw training data 109 of FIG. 1). The memory module 102 can use the host interface 216 of FIG. 2 and/or the local processor 212 of FIG. 2 to detect the incoming raw data. In some embodiments, such as for CXL interfaces, the raw training data 109 can be received as or inside of a communicated packet. When the raw data is detected, the memory module 102 can receive the incoming data, as shown at block 558. For example, the memory module 102 can temporarily store the received packet and/or the raw training data 109 therein at the buffers 218 of FIG. 2. Operations regarding other types of communications, including checkpointing processes, are further described below.

At decision block 560, he memory module 102 can determine (using, e.g., the module controller 132 of FIG. 1 and/or the local processor 212) whether the currently closed rank includes the raw training data received during the previous iteration or from the earlier packet. The memory module 102 can track the iterations, the received raw data/packets, and/or the like. Accordingly, the memory module 102 can determine whether the memory ranks that are closed to communication have stored therein raw training data that has not been preprocessed.

When the closed ranks have been used and they include raw training data, the memory module 102 can use the NPUs 152 to compute within the closed ranks and operate on the raw training data therein. The NPUs 152 can operate on the data according to predetermined instructions. For example, the NPUs 152 can reformat the raw training data within the closed ranks according to predetermined instructions and formats stored in the embedded data, according to configuration (e.g., logic setting) of the NPUs 152, and/or the like. The NPUs 152 can store the corresponding results (e.g., the preprocessed training data 302 of FIG. 3B) in the closed ranks. The memory module can operate on the raw training data in correspondence with the processes described for block 524 of FIG. 5A.

In parallel to operating the NPUs or when the closed ranks were not previously used (e.g., as notified by all bits being set to ‘0’ or ‘1’ or a different data pattern), the memory module 102 can determine whether processing results from the previous iteration are within the currently open ranks. In other words, the memory module 102 can determine the determination from the decision block 560 during the previous iteration. When the data stored in the opened rank is the result (e.g., the preprocessed training data 302) from operating on raw data, the memory module 102 can read the results from the opened ranks as shown at block 566. At block 568, the memory module 102 can store the read results along with the corresponding identifiers in the persistent memory 136 of FIG. 1. At block 570, the memory module can send the results to one or more of the hosts 202 of FIG. 2. The memory module 102 can store and send the results in accordance with the processes described above for blocks 526 and 528 of FIG. 5A.

When the opened rank is empty (e.g., without results) or after reading the results, the memory module 102 can write the currently received raw data (from block 558) into the open rank as shown at block 572. For example, the memory module 102 can divide the packet of raw training data according to a predetermined process and write each of the divided segments into an opened rank within one of the channels. The communications to and/or from the opened rank can be implemented while the NPUs 152 operate on the data in the closed rank. Accordingly, the memory module 102 can operate on/compute with one set of raw data in parallel to sending the previously processed result and/or preparing the newly received raw data.

After writing the raw data into the open rank, the memory module 102 can adjust the selection status 258. Accordingly, the closed rank can be opened for communication, and the currently open rank can be closed with the NPU assigned thereto, thereby beginning a new/subsequent iteration. The memory module 102 can perform the parallel processing shown in blocks 556-574 on the newly opened and closed ranks as described above.

For narrative purposes and to highlight the parallel processing, the memory module 102 is shown reading, storing, and sending the preprocessed training data after or when the data is received. However, it is understood that the memory module 102 can read, store, and send the preprocessed training data at the beginning of the iteration after the status is adjusted.

The memory module 102 can further perform other operations outside of the parallel processing. For example, the memory module 102 can provide faster checkpoint support for AI model training. Using the example illustrated in FIG. 5B, when the received communication does not include raw training data, the memory module 102 can determine whether the received communication is a checkpoint command and corresponding identifier for accessing previously computed results, as shown in decision block 582. When the memory module 102 receives the checkpoint command, the memory module 102 can read the corresponding and previously generated preprocessed result from the persistent memory 136 as shown at block 584. The memory module 102 can thus reproduce the preprocessed result without recomputing or re-operating on the raw training data. The memory module 102 can send the backed up result to one or more of the hosts 202 based on the access to the persistent memory 136.

### Example Embodiments

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example, and the independent examples may be combined in whole and/or in parts with other independent examples. The other examples can be presented in a similar manner.

1. An example computing system comprising:
a central computing module configured as a master processor for the computing system, wherein the central computing module is configured to access raw training data;
a memory module external to and communicatively coupled to the central computing module, the memory module configured to:
   receive the raw training data from the central computing module;
   generate a preprocessed training data based on operating on the raw training data; and
an accelerator module communicatively coupled to the central computing module and configured to perform computations as commanded by the master processor, wherein the performed computations include training an Artificial Intelligence (AI) model using the preprocessed training data.

2. The system of one or more examples herein, one or more portions thereof, or a combination thereof, wherein:
the central computing module accesses the raw training data from a network storage device and commands the external memory module to preprocess the raw training data; and
the accelerator module receives the preprocessed training data, resulting from preprocessing the raw training data, for the AI model training instead of the raw training data.

3. The system of one or more examples herein, one or more portions thereof, or a combination thereof, wherein:
the central computing module includes a Central Processing Unit (CPU); and
the accelerator module includes a Graphics Processing Unit (GPU).

4. The system of one or more examples herein, one or more portions thereof, or a combination thereof, wherein the memory module is a Compute Express Link (CXL) memory drive having a CXL interface circuit configured to communicate with the central computing module.

5. The system of one or more examples herein, including example 4, one or more portions thereof, or a combination thereof, wherein the memory module is a Compute Express Link (CXL) memory drive having a CXL interface circuit configured to communicate with the central computing module.

6. The system of one or more examples herein, one or more portions thereof, or a combination thereof, wherein the central computing module is configured to receive the preprocessed training data from the memory module and then send the preprocessed training data to the accelerator module (e.g., wherein the memory module is configured to communicate the preprocessed training data to the accelerator module through the central computing module).

7. The system of one or more examples herein, one or more portions thereof, or a combination thereof, wherein the memory module is configured to directly provide the preprocessed training data to the accelerator module (e.g., without communicating through the central computing module).

8. The system of one or more examples herein, including example 7, one or more portions thereof, or a combination thereof, wherein the memory module includes an interface circuit configured to directly communicate with the accelerator module according to a Compute Express Link (CXL) protocol, an Ultra Accelerator Link (UAL) protocol, a manufacturer-specific communication protocol, a Graphics Processing Unit (GPU) direct storage protocol, an Ethernet protocol, a Peripheral Component Interconnect (PCI) protocol, or a derivative thereof, or a combination thereof.

9. The system of one or more examples herein, one or more portions thereof, or a combination thereof, wherein the memory module includes multiple Neural Processing Units (NPUs) configured to generate the preprocessed training data.

10. The system of one or more examples herein, including example 9, one or more portions thereof, or a combination thereof, wherein the memory module is configured to use the NPUs to operate on a reference set of raw data while (1) sending out a preprocessing result generated from operating on a preceding set of raw data received before the reference set, (2) receiving a next set of raw data after having received the reference set, or a combination thereof.

11. The system of one or more examples herein, including example 10, one or more portions thereof, or a combination thereof, wherein:
the memory module includes a set of memory cells arranged according to multiple channels that are configured to separately and independently facilitate internal communications and/or access; and
the NPUs are each assigned to one of the multiple channels, wherein each of the NPUs are configured to operate on data stored within the assigned channel.

12. The system of one or more examples herein, including example 11, one or more portions thereof, or a combination thereof, wherein:
the set of memory cells are further arranged according to two or more ranks within each channel; and
the memory module includes logic (e.g., Register Transfer Level (RTL) logic) configured to:
   provide open communicative access to a first rank in the two or more ranks for a channel, such as for writing the raw training data and/or reading the preprocessed training data from the opened rank; and
   couple an NPU assigned to the channel to a second rank in the two or more ranks, wherein the NPU is configured to operate on data stored therein while (concurrently with/simultaneously as/parallel to) communicating the raw training data to and/or the preprocessed training data from the first rank.

13. The system of one or more examples herein, including example 11, one or more portions thereof, or a combination thereof, wherein the set of memory cells is Dynamic Random-Access Memory (DRAM).

14. The system of one or more examples herein, including example 13, one or more portions thereof, or a combination thereof, wherein the memory module further includes persistent memory (e.g., Flash memory) configured to store the preprocessed training data.

15. The system of one or more examples herein, including example 14, one or more portions thereof, or a combination thereof, wherein:
the central computing module is configured to request the preprocessed training data (e.g., using a storage identifier generated and provided by the memory module) after the memory module initially provided the preprocessed training data; and
the memory module is configured to resend the preprocessed training data based on accessing the persistent memory (e.g., without recomputing the preprocessed training data with the raw training data).

16. An example method of operating a computing system, the method including one or more functions/processes of examples herein, including examples 1 through 15.

17. An example apparatus comprising:
a communication interface configured to (1) receive raw training data from an external device and (2) send preprocessed training data to the external device or a different external device;
a set of memory cells coupled to the communication interface and configured to store the raw training data and the preprocessed training data, wherein the set of memory cells is arranged according to multiple channels that are configured to separately and independently facilitate internal communications and/or access, wherein each channel includes two or more ranks; and
local processor circuits (e.g., Neural Processing Units (NPUs)) coupled to the set of memory cells and configured to operate on the raw training data stored in the multiple channels to generate the preprocessed training data, wherein at least one local processor logic is uniquely assigned to each channel.

18. The apparatus of one or more examples herein, including example 17, one or more portions thereof, or a combination thereof, wherein the apparatus comprises the memory module of examples 1-16.

19. The apparatus of one or more examples herein, including example 17, one or more portions thereof, or a combination thereof, wherein the apparatus further comprises:
a local memory controller configured to communicate the raw training data and the preprocessed training data while the local processor logic operates on the raw training data to generate the preprocessed training data.

20. The apparatus of one or more examples herein, including example 19, one or more portions thereof, or a combination thereof, wherein:
the raw training data is stored on a first rank within the multiple channels; and
the local memory controller is configured to operate the NPUs to generate the preprocessed training data within the first rank of the multiple channels while (1) sending a prior preprocessing result s, (2) receiving a next set of raw data, or a combination thereof.

21. The apparatus of one or more examples herein, including example 17, one or more portions thereof, or a combination thereof, wherein the apparatus further comprises:
persistent memory coupled to the local processor circuit and configured to store the preprocessed training data before or while sending the preprocessed training data.

22. The apparatus of one or more examples herein, including example 21, one or more portions thereof, or a combination thereof, wherein the apparatus is configured to provide access to the preprocessed training data (e.g., without recomputing the preprocessed training data from the raw training data) after sending the preprocessed training data.

23. The apparatus of one or more examples herein, including example 21, one or more portions thereof, or a combination thereof, wherein:
the set of memory cells comprise Dynamic Random Access Memory (DRAM); and
the persistent memory is Flash memory.

24. The apparatus of one or more examples herein, including example 17, one or more portions thereof, or a combination thereof, wherein the communication interface is configured according to a Compute Express Link (CXL) protocol, an Ultra Accelerator Link (UAL) protocol, a Graphics Processing Unit (GPU) direct storage protocol, an Ethernet protocol, a Peripheral Component Interconnect (PCI) protocol, or a derivative thereof, or a combination thereof.

25. The apparatus of one or more examples herein, including example 24, one or more portions thereof, or a combination thereof, wherein the set of memory cells are arranged to provide at least four memory channels that (1) each include at least two memory ranks and (2) each correspond to one unique NPU.

26 The apparatus of one or more examples herein, including example 17, one or more portions thereof, or a combination thereof, wherein the local processor circuits are configured to generate the preprocessed training data based on reformatting the raw training data, wherein the preprocessed training data is configured to be used by an accelerator module (e.g., a Graphics Processing Unit (GPU)) to train an Artificial Intelligence (AI) model.

27 The apparatus of one or more examples herein, including example 17, one or more portions thereof, or a combination thereof, wherein:
the communication interface is configured to (1) receive the raw training data from a Central Processing Unit (CPU) and (2) send the preprocessed training data to a Graphics Processing Unit (GPU) that uses the preprocessed training data to train an Artificial Intelligence (AI) model.

28. The apparatus of one or more examples herein, including example 27, one or more portions thereof, or a combination thereof, wherein the communication interface is configured to send the send the preprocessed training data directly to the GPU.

29. The apparatus of one or more examples herein, including example 27 one or more portions thereof, or a combination thereof, wherein the communication interface is configured to send the send the preprocessed training data to the GPU through the CPU.

30 The apparatus of one or more examples herein, including example 20, one or more portions thereof, or a combination thereof, wherein the communication interface is configured according to a Compute Express Link (CXL) protocol, an Ultra Accelerator Link (UAL) protocol, a Graphics Processing Unit (GPU) direct storage protocol, an Ethernet protocol, a Peripheral Component Interconnect (PCI) protocol, or a derivative thereof, or a combination thereof.

31. An example method of operating a computing system, the method including one or more functions/processes of examples herein, including examples 17 through 30.

### Example System

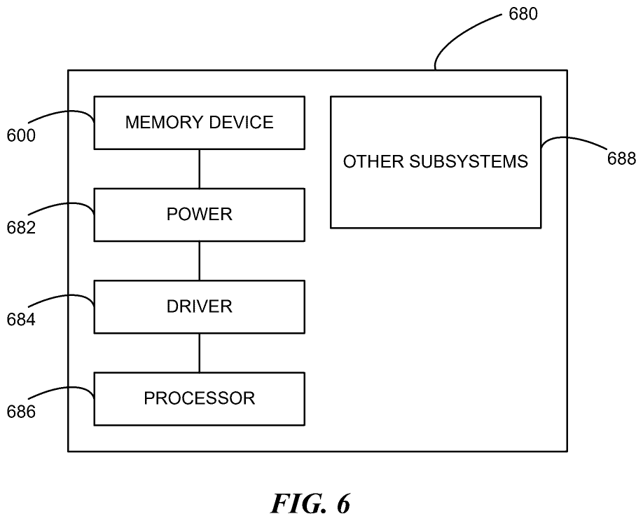

FIG. 6 is a schematic view of a system that includes an apparatus in accordance with embodiments of the present technology. Any one of the foregoing apparatuses (e.g., memory devices) described above with reference to FIGS. 1-5B can be incorporated into any of a myriad of larger and/or more complex systems, a representative example of which is system 680 shown schematically in FIG. 6. The system 680 can include a memory device 600, a power source 682, a driver 684, a processor 686, and/or other subsystems or components 688. The memory device 600 can include features generally similar to those of the apparatus described above with reference to FIGS. 1-5B, and can therefore include various features for performing a direct read request from a host device. The resulting system 680 can perform any of a wide variety of functions, such as memory storage, data processing, and/or other suitable functions. Accordingly, representative systems 680 can include, without limitation, hand-held devices (e.g., mobile phones, tablets, digital readers, and digital audio players), computers, vehicles, appliances and other products. Components of the system 680 may be housed in a single unit or distributed over multiple, interconnected units (e.g., through a communications network). The components of the system 680 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of DRAM devices. Apparatuses configured in accordance with other embodiments of the present technology, however, can include other types of suitable storage media in addition to or in lieu of DRAM devices, such as, devices incorporating NAND-based or NOR-based non-volatile storage media (e.g., NAND flash), magnetic storage media, phase-change storage media, ferroelectric storage media, etc.

The term “processing” as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term “dynamic” as used herein describes processes, functions, actions or implementation occurring during operation, usage or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to FIGS. 1-6.

I/We claim:

1. An apparatus comprising:
a communication interface configured to (1) receive raw training data from an external Central Processing Unit (CPU) and (2) send preprocessed training data to the external CPU;
a set of memory cells coupled to the communication interface and configured to store the raw training data and the preprocessed training data, wherein the set of memory cells is arranged according to multiple channels that are configured to separately and independently facilitate internal communications and/or access, wherein each channel includes two or more ranks; and
Neural Processing Units (NPUs) coupled to the set of memory cells and configured to operate on the raw training data stored in the multiple channels to generate the preprocessed training data based on reformatting the raw training data,
wherein the preprocessed training data is configured to be used by an accelerator module to train an Artificial Intelligence (AI) model, and
wherein at least one of the NPUs is uniquely assigned to each channel.

2. The apparatus of claim 1, further comprising:
a local memory controller configured to manage internal communications of the raw training data and the preprocessed training data to and from the set of memory cells while operating the NPUs.

3. The apparatus of claim 2, wherein:
the each channel for the set of memory cells includes a first rank and a second rank;
the raw training data is stored on the first rank within the multiple channels; and
the local memory controller is configured to operate the NPUs to generate the preprocessed training data within the first rank of the multiple channels while (1) sending a prior preprocessing result, (2) receiving a next set of raw data, or a combination thereof to the second rank within the multiple channels.

4. The apparatus of claim 1, further comprising:
persistent memory coupled to the local processor circuit and configured to store the preprocessed training data before or while sending the preprocessed training data.

5. The apparatus of claim 4, wherein the apparatus is configured to provide access to the preprocessed training data from the persistent memory after sending the preprocessed training data.

6. The apparatus of claim 4, wherein:
the communication interface is configured to receive a checkpoint command associated with accessing or reverting to a prior version of the AI model; and
the apparatus further comprising:
a local memory controller configured to obtain, in response to the checkpoint command, the stored preprocessed training data from the persistent memory without operating on the raw training data after the reception of the checkpoint command.

7. The apparatus of claim 1, wherein:
the set of memory cells comprise Dynamic Random Access Memory (DRAM); and
the persistent memory is Flash memory.

8. The apparatus of claim 1, wherein the communication interface is configured according to a Compute Express Link (CXL) protocol, an Ultra Accelerator Link (UAL) protocol, a Graphics Processing Unit (GPU) direct storage protocol, an Ethernet protocol, a Peripheral Component Interconnect (PCI) protocol, or a derivative thereof, or a combination thereof.

9. The apparatus of claim 8, wherein the set of memory cells are arranged to provide at least four memory channels that (1) each include two memory ranks and (2) each correspond to one unique NPU.

10. The apparatus of claim 1, wherein the communication interface is configured to (1) receive the raw training data from a Central Processing Unit (CPU) and (2) send the preprocessed training data for a Graphics Processing Unit (GPU) to use the preprocessed training data to train the AI model.

11. The apparatus of claim 10, wherein the communication interface is configured to send the preprocessed training data directly to the GPU.

12. The apparatus of claim 10, wherein the communication interface is configured to send the preprocessed training data to the GPU through the CPU.

13. A Compute Express Link (CXL) memory drive comprising:
a CXL interface configured to communicate with an external Central Processing Unit (CPU),
wherein the communication includes:
receiving a first raw data;
receiving a second raw data after the first raw data;
sending a first preprocessed data associated with the first raw data; and
sending a second preprocessed data associated with the first raw data after sending the first preprocessed data, wherein the first and second preprocessed data are configured for training an Artificial Intelligence (AI) model;
Dynamic Random Access Memory (DRAM) devices coupled to the communication interface and including a set of memory cells arranged into multiple channels each including at least a first rank and a second rank;
Multiple Neural Processing Units (NPUs) configured to generate the first and second preprocessed data by reformatting the first and second raw data, respectively, wherein each of the NPUs is uniquely coupled to one of the multiple channels;
a memory controller coupled to the CXL interface and the DRAM devices, the memory controller configured to:
write the first raw data to the first rank of the multiple channels;
concurrently (1) operate the NPUs to generate the first preprocessed data from the first raw data in the first rank of the multiple channels while (2) writing the second raw data to the second rank of the multiple channels;
after generating the first preprocessed data, operate the NPUs to generate the second preprocessed data from the second raw data in the second rank of the multiple channels while reading the first preprocessed data from the first raw data.

14. The CXL memory drive of claim 13, wherein:
the CXL interface is configured to:
receive a third raw data; and
send a third preprocessed data resulting from operating on the third raw data; and
the memory controller is configured to:
after reading the first preprocessed data, write the third raw data to the first rank of the multiple channels while generating the second preprocessed data;
after generating the second preprocessed data, (1) operate the NPUs to generate the third preprocessed data based on reformatting the third raw data in the first rank while (2) reading the second preprocessed data from the second rank.

15. The CXL memory drive of claim 13, further comprising:
Flash memory devices coupled to the memory controller and configured to store the first preprocessed data for checkpointing and reverting the AI model to a version associated with the first preprocessed data without operating on the first raw data after sending the first preprocessed data.

16. A method of operating a memory drive, the method comprising:
receiving a first raw data from an external device using a communication interface of the memory drive;
writing the first raw data into first ranks within multiple channels of memory locations;
concurrently (1) operating Neural Processing Units (NPUs) that are within the memory drive and coupled to the multiple channels to generate a first preprocessed data by reformatting the first raw data in the first ranks while (2) receiving a second raw data using the communication interface and then (3) writing the second raw data into second ranks within the multiple channels of memory locations;
after generating the first preprocessed data, concurrently (1) operating the NPUs to generate a second preprocessed data by reformatting the second raw data in the second ranks while (2) reading the first preprocessed data and/or (3) sending the first preprocessed data to the external device using the communication interface; and
after generating the second preprocessed data, sending the second preprocessed data to the external device using the communication interface, wherein the first and second preprocessed data are results of preprocessing raw data in preparation for training an Artificial Intelligence (AI) model.

17. The method of claim 16, further comprising:
receiving a third raw data from the external device using the communication interface while generating the second preprocessed data;
writing the third raw data into the first ranks after reading the first preprocessed data from the first ranks and while generating the second preprocessed data; and
after generating the second preprocessed data, concurrently (1) operating the NPUs to generate a third preprocessed data by reformatting the third raw data in the first ranks while (2) reading the second preprocessed data from the second ranks and/or (3) sending the second preprocessed data to the external device using the communication interface.

18. The method of claim 16, further comprising:
storing the first preprocessed data in a persistent memory device within the memory drive before or while sending the first preprocessed data to the external device.

19. The method of claim 18, further comprising:
receiving a checkpoint command associated with accessing or reverting to a prior version of the AI model; and
obtaining, in response to the checkpoint command, the stored preprocessed training data from the persistent memory without operating on the first raw data after the reception of the checkpoint command.

20. The method of claim 16, further comprising:
maintaining a selection status for each of the first or second ranks, wherein maintaining the status includes:
opening the first ranks and closing the second ranks for communication before writing the first raw data into the first ranks;
closing the first ranks and opening the second ranks for communication while connecting the NPUs to the first ranks after writing the first raw data; and
opening the first ranks and closing the second ranks while connecting the NPUs to the second ranks after generating the first processed data.
